(19) United States
(12) Patent Application Publication
(10) Pub. No.: US 2023/0087874 A1
(43) Pub. Date: Mar. 23, 2023

(54) MONITORING CONTROL DEVICE AND CLIENT PC

(71) Applicants: KABUSHIKI KAISHA TOSHIBA, Tokyo (JP); TOSHIBA ENERGY SYSTEMS & SOLUTIONS CORPORATION, Kawasaki-shi, Kanagawa (JP)

(72) Inventor: Chikashi SHINOHARA, Chofu Tokyo (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(21) Appl. No.: 17/904,550

(22) PCT Filed: Sep. 23, 2020
(86) PCT No.: PCT/JP2020/035829

§ 371 Date: Aug. 18, 2022

(30) Foreign Application Priority Data
Feb. 18, 2020 (JP) 2020-025526

(51) Int. Cl. G06F 21/12; G06F 21/10

(52) U.S. Cl. CPC G06F 21/12; G06F 21/105; G06F 2221/0704

(57) ABSTRACT

A monitoring control device according to an embodiment includes a host-side storage unit and a host-side processor. The host-side storage unit is configured to store an HMI program configured to generate a monitoring operation screen, host-side remote monitoring software configured to establish connection between an own device and a client PC according to a remote desktop protocol and send the monitoring operation screen to the client PC, and a key code. The host-side processor is configured to execute the host-side remote monitoring software and the HMI program. The host-side remote monitoring software is configured to virtualize a dongle connected to the client PC, as a dongle connected to the monitoring control device. The HMI program is configured to end execution of the HMI program if the key code stored in the virtualized dongle does not match with the key code stored in the host-side storage unit.

### FIELD

The present invention relates to a monitoring control device and a client PC.

### BACKGROUND

A technology has been developed by which a monitoring control device in a control system is remotely monitored using a client PC according to a remote desktop function. More particularly, the monitoring control device executes an HMI program and generates a monitoring operation screen; and the monitoring operating screen is displayed in the display of the client PC according to the remote desktop function.

### CITATION LIST

### Patent Literature

Patent Literature 1: Japanese Patent No. 5732374

Patent Literature 2: Japanese Patent No. 5561525

### SUMMARY OF THE INVENTION

### Problem to be Solved by the Invention

As far as the methods for managing the license for using the HMI program are concerned, there are user-based license management methods in which the license is managed on the basis of the users of client PCs, and there are device-based license management methods in which the license is managed on the basis of the client PCs. In the monitoring control device, a device-based license management method is implemented.

As far as the device-based license management methods are concerned, there is a method in which the authentication for license management of the HMI program is performed using the unique value of the concerned client PC such as the MAC address for Ethernet, and there is a method in which the authentication for license management of the HMI program is performed using a key code stored in a dongle. In the monitoring control device, the authentication for license management of the HMI program is performed using a dongle connected to the monitoring control device.

More particularly, the HMI program determines whether or not the key code stored in the dongle matches with a preregistered key code. If the key code stored in the dongle matches with the preregistered key code, then the HMI program displays a monitoring operation screen in the display of the concerned client PC. On the other hand, if the key code stored in the dongle does not match with the preregistered key code, then the operations of the HMI program are ended.

However, in the case of implementing the method in which the authentication for license management of the HMI program is performed using a key code that is stored in a dongle connected to the monitoring control device; if a plurality of client PCs gets connected to the monitoring control device, then the HMI program corresponding to each client PC is executed, and all HMI programs authenticate the corresponding client PCs using the key code stored in the same dongle. For that reason, it becomes difficult to prevent a situation in which a client PC not having the license for using the HMI program gets connected to the monitoring control device in an unauthorized manner.

### Means for Solving Problem

A monitoring control device according to an embodiment includes a host-side storage unit and a host-side processor. The host-side storage unit is configured to store an HMI program, host-side remote monitoring software, and a key code, the HMI program being configured to generate a monitoring operation screen, the host-side remote monitoring software being configured to establish connection between an own device and a client PC according to a remote desktop protocol and send the monitoring operation screen to the client PC. The host-side processor is configured to execute the host-side remote monitoring software and the HMI program. The host-side remote monitoring software is configured to virtualize a dongle connected to the client PC, as a dongle connected to the monitoring control device. The HMI program is configured to end execution of the HMI program if the key code stored in the virtualized dongle does not match with the key code stored in the host-side storage unit.

### BRIEF DESCRIPTION OF DRAWINGS

FIG. 1 is an exemplary configuration of a remote monitoring system according to a first embodiment.

FIG. 2 is a diagram for explaining an example of the operations performed for displaying an HMI screen in a client PC in the remote monitoring system according to the first embodiment.

FIG. 3 is a flowchart for explaining an exemplary flow of a display operation performed by a client PC in the remote monitoring system according to the first embodiment for displaying the HMI screen.

FIG. 4 is a flowchart for explaining an exemplary flow of a transmission operation performed by a host PC in the remote monitoring system according to the first embodiment for sending an HMI screen.

FIG. 5 is a flowchart for explaining an example of the detailed flow of the transmission operation performed by the host PC in the remote monitoring system according to the first embodiment for sending an HMI screen.

FIG. 6 is a diagram for explaining an example of the operations performed for displaying an HMI screen in a client PC in the remote monitoring system according to a second embodiment.

FIG. 7 is a diagram for explaining an example of the operations performed for displaying HMI screens in a client PC in the remote monitoring system according to a third embodiment.

### DETAILED DESCRIPTION

Exemplary embodiments of a remote monitoring system, which has a monitoring control device and a client PC installed therein, are described below with reference to the accompanying drawings.

### First Embodiment

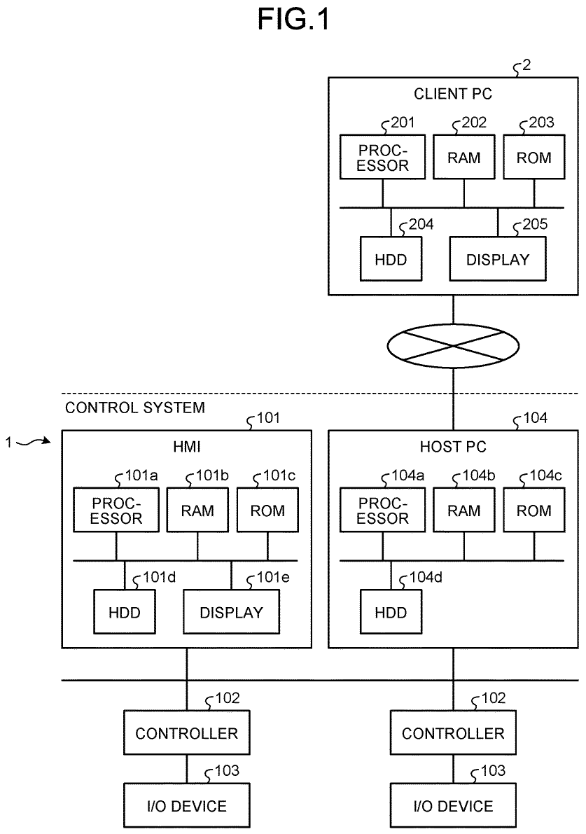

Firstly, explained below with reference to FIG. 1 is an exemplary configuration of a remote monitoring system according to a first embodiment.

FIG. 1 is a diagram illustrating an exemplary configuration of the remote monitoring system according to the first embodiment.

As illustrated in FIG. 1, the remote monitoring system according to the first embodiment includes a control system 1 and a client PC 2 meant for remote monitoring. The control system 1 and the client PC 2 meant for remote monitoring are communicably communicated to each other via a network such as a WAN (Wide Area Network).

Firstly, the explanation is given about an exemplary functional configuration of the client PC 2 meant for remote monitoring.

The client PC 2 meant for remote monitoring represents an example of an HMI meant for remote monitoring and includes a general-purpose personal computer. More particularly, the client PC 2 meant for remote monitoring includes a processor 201 such as a CPU (Central Processing Unit), a RAM (Random Access Memory) 202, a ROM (Read Only Memory) 203, an HDD (Hard Disk Drive) 204, and a display 205.

The RAM 202 is used as the work area when the processor 201 executes various programs. The ROM 203 and the HDD 204 are used to store a variety of information such as the OS (Operating System), such as Windows (registered trademark), that is run by the processor 201.

Using the RAM 202 as the work area, the processor 201 executes various programs, such as the OS, stored in a memory device such as the ROM 203 or the HDD 204.

The OS represents an example of an OS such as Windows (registered trademark) in which a client-side remote monitoring software is installed. The client-side remote monitoring software represents an example of software meant for establishing remote desktop connection between itself (the client PC 2) and a host PC 104 (explained later) according to a remote desktop protocol.

More particularly, the client-side remote monitoring software receives a monitoring operation screen (hereinafter, called an HMI screen) from the host PC 104 (explained later), and displays the received HMI screen in the display 205. The HMI screen is used for monitoring and operating the control system, and is generated by an HMI program (explained later).

Given below is the explanation of an exemplary configuration of the control system 1.

As illustrated in FIG. 1, the control system 1 includes an HMI 101 meant for field monitoring, a controller 102, an I/O device 103, and the host PC 104. The HMI 101 meant for field monitoring, the controller 102, the I/O device 103, and the host PC 104 are communicably connected to each other by a LAN (Local Area Network).

The I/O device 103 is an interface for enabling the controller 102 to receive input of a variety of signals from external devices and to output a variety of signals to external devices.

The controller 102 represents an example of a control device such as a PLC (Programmable Logic Controller) that controls the various devices present in the control system 1 (for example, valves and sensors constituting a plant).

The HMI 101 meant for field monitoring is a device used by the field operator for monitoring the status of the operations performed by the controller 102.

In the first embodiment, the HMI 101 meant for field monitoring represents an example of an HMI including a general-purpose personal computer.

The HMI 101 meant for field monitoring includes a processor 101a such as a CPU, a RAM 101b, a ROM 101c, an HDD 101d, and a display 101e.

The RAM 101b is used as the work area when the processor 101a executes various programs. The ROM 101c and the HDD 101d are used to store the OS, such as Windows (registered trademark), and the HMI program that are executed by the processor 101a, and to store a variety of information such as a key code.

Using the RAM 101b as the work area, the processor 101a executes various programs such as the OS, such as Windows (registered trademark), and the HMI program that are stored in a memory device such as the ROM 101c or the HDD 101d.

Herein, if the key code stored in a dongle (a hardware key), which is connected to the HMI 101 meant for field monitoring, matches with the key code stored in advance in the ROM 101c or the HDD 101d, then the HMI program generates an HMI screen and displays it in the display 101e. As a result, it becomes possible to prevent a situation in which a device not having the license for using the HMI program executes the HMI program and displays the HMI screen in the display 101e.

The host PC 104 represents an example of a monitoring control device including a general-purpose personal computer. The host PC 104 includes a processor 104a such as a CPU, a RAM 104b, a ROM 104c, and an HDD 104d.

The RAM 104b is used as the work area when the processor 104a executes various programs. The ROM 104c and the HDD 104d are used to store the OS, such as Windows (registered trademark), and the HMI program that are executed by the processor 104a, and to store a variety of information such as a key code.

Using the RAM 104b as the work area, the processor 104a executes various programs such as the OS, such as Windows (registered trademark), and the HMI program that are stored in a memory device such as the ROM 104c or the HDD 104d.

The OS is an OS such as Windows (registered trademark) in which host-side remote monitoring software is installed. The host-side remote monitoring software establishes remote desktop connection between the own device (the host PC 104) and the client PC 2 according to a remote desktop protocol. More particularly, the host-side remote monitoring software represents an example of software meant for sending, to the client PC, the HMI screen generated by the HMI program (explained later). The HMI program generates a GUI such as an HMI screen. As a result, the host PC 104 displays the GUI, such as the HMI screen, in the display 205 of the client PC 2; and hence makes it possible to operate the host PC 104 from the client PC 2.

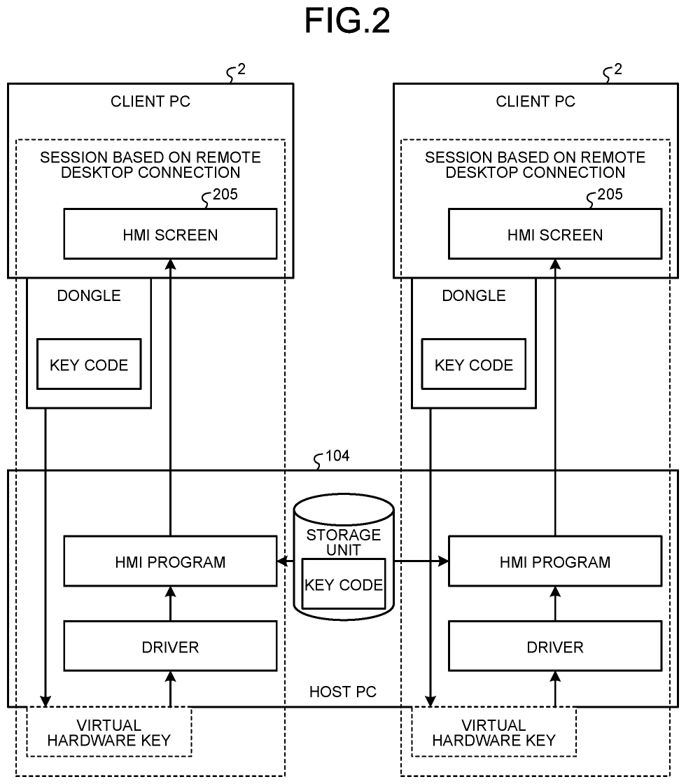

Explained below with reference to FIG. 2 is an example of the operations performed for displaying the HMI screen in the client PC 2 meant for remote monitoring in the remote monitoring system according to the first embodiment.

FIG. 2 is a diagram for explaining an example of the operations performed for displaying the HMI screen in a client PC in the remote monitoring system according to the first embodiment.

Firstly, the processor 104a of the host PC 104 executes the host-side remote monitoring software and starts a session of remote desktop connection between the host PC 104 and the client PC 2. The host-side remote monitoring software (for example, a remote FX) virtualizes the dongle (hardware key), which is connected to the client PC 2, into a dongle (virtualized hardware key) connected to the own device (the host PC 104).

Then, the processor 104a executes the HMI program. If the key code read from the virtualized hardware key using a driver included in the host PC 104 matches with the key code stored in a storage unit such as the ROM 104c or the HDD 104d, then the HMI program generates an HMI screen. Subsequently, the host-side remote monitoring software sends the generated HMI screen to the client PC 2. On the other hand, if the key code read from the virtualized hardware key does not match with the key code stored in the storage unit, then the execution of the HMI program is ended.

Thus, when remote desktop connection with the host PC 104 is established by a plurality of client PCs 2, the HMI program corresponding to each client PC 2 can authenticate the concerned client PC 2 using the key code stored in the dongle that is connected to the concerned client PC 2. As a result, any client PC 2 not having the license for using the HMI program can be prevented from displaying the HMI screen in an unauthorized manner.

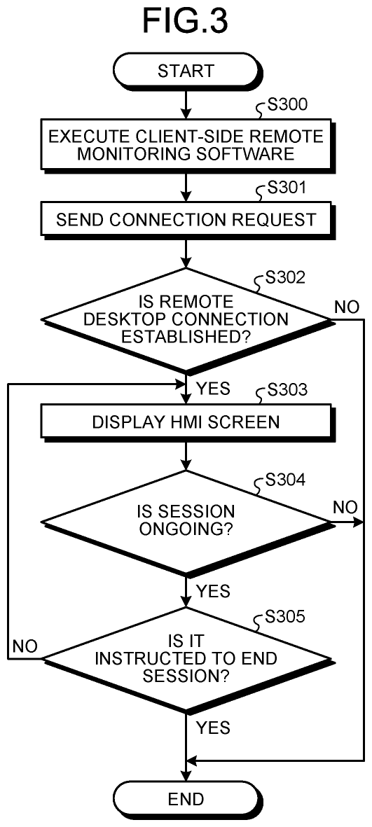

Explained below with reference to FIG. 3 is an exemplary flow of a display operation performed in the client PC 2 according to the first embodiment for displaying the HMI screen.

FIG. 3 is a flowchart for explaining an exemplary flow of the display operation performed by a client PC in the remote monitoring system according to the first embodiment for displaying the HMI screen.

The processor 201 of the client PC 2 starts executing the client-side remote monitoring software installed in the OS and stored in a storage unit such as the ROM 203 or the HDD 204 (Step S300).

The client-side remote monitoring software firstly sends a connection request to the host PC 104 for establishing remote desktop connection (Step S301).

Then, the client-side remote monitoring software determines whether or not remote desktop connection is established between the client PC 2 and the host PC 104 (Step S302).

If there is failure in establishing remote desktop connection between the client PC 2 and the host PC 104 (No at Step S302), then the client-side remote monitoring software terminates the remote desktop connection between the client PC 2 and the host PC 104.

On the other hand, if remote desktop connection between the client PC 2 and the host PC 104 is successfully established (Yes at Step S302), then the client-side remote monitoring software starts a session based on remote desktop connection with the host PC 104; receives the HMI screen from the host PC 104; and displays the received HMI screen in the display 205 (Step S303).

Then, the client-side remote monitoring software determines whether or not the session based on remote desktop connection is ongoing between the client PC 2 and the host PC 104 (Step S304). If the session based on remote desktop connection between the client PC 2 and the host PC 104 is not ongoing (No at Step S304), then the client-side remote monitoring software terminates the remote desktop connection between the client PC 2 and the host PC 104.

On the other hand, if the session based on remote desktop connection is ongoing between the client PC 2 and the host PC 104 (Yes at Step S304), then the client-side remote monitoring software determines whether or not an instruction is issued to end the session that is based on remote desktop connection between the client PC 2 and the host PC 104 (Step S305). If an instruction is issued to end the session that is based on remote desktop connection between the client PC 2 and the host PC 104 (Yes at Step S305), then the client-side remote monitoring software ends the session that is based on remote desktop connection between the client PC 2 and the host PC 104.

On the other hand, if no instruction is issued to end the session that is based on remote desktop connection between the client PC 2 and the host PC 104 (No at Step S305), then the system control returns to Step S303.

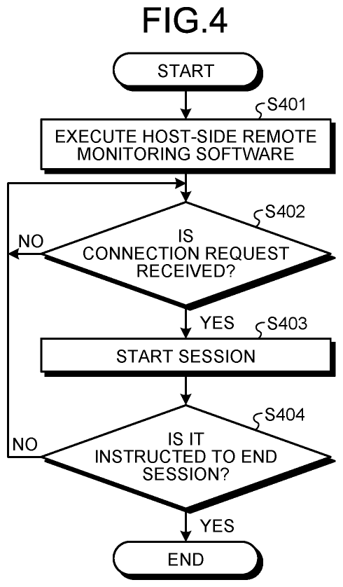

Explained below with reference to FIG. 4 is an exemplary flow of a transmission operation performed by the host PC 104 according to the first embodiment for sending the HMI screen.

FIG. 4 is a flowchart for explaining an exemplary flow of a transmission operation performed by the host PC in the remote monitoring system according to the first embodiment for sending the HMI screen.

When the host PC 104 is booted, the processor 104a thereof starts executing the host-side remote monitoring software installed in the OS and stored in a storage unit such as the ROM 104c or the HDD 104d (Step S401).

Then, the host-side remote monitoring software determines whether or not a connection request based on remote desktop connection is received from the client PC 2 (Step S402). If a connection request based on remote desktop connection is not received from the client PC 2 (No at Step S402), then the system control returns to Step S402.

On the other hand, if a connection request based on remote desktop connection is received from the client PC 2 (Yes at Step S402), then the host-side remote monitoring software starts a session with the client PC 2 based on remote desktop connection (Step S403).

Then, the host-side remote monitoring software determines whether or not an instruction is issued to end the session that is based on remote desktop connection between the client PC 2 and the host PC 104 (Step S404). If an instruction is issued to end the session that is based on remote desktop connection between the client PC 2 and the host PC 104 (Yes at Step S404), then the host-side remote monitoring software ends the session that is based on remote desktop connection between the client PC 2 and the host PC 104.

On the other hand, if no instruction is issued to end the session that is based on remote desktop connection between the client PC 2 and the host PC 104 (No at Step S404), then the system control returns to Step S402.

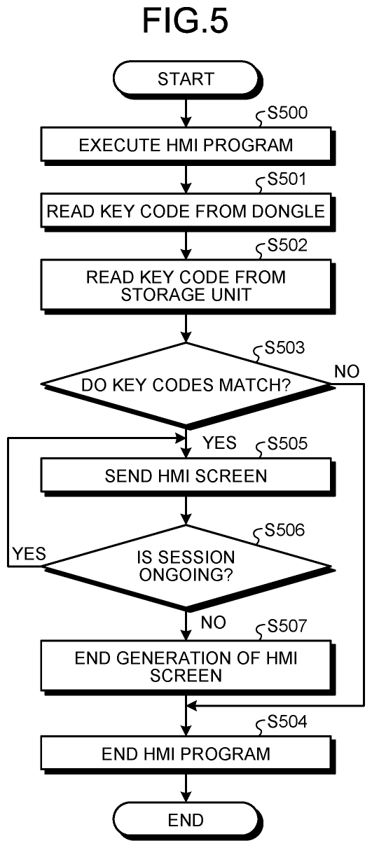

Explained below with reference to FIG. 5 is an exemplary flow of the transmission operation performed by the host PC 104 for sending the HMI screen.

FIG. 5 is a flowchart for explaining an example of the detailed flow of the transmission operation performed by the host PC in the remote monitoring system according to the first embodiment for sending the HMI screen.

When the session based on remote desktop connection with the client PC 2 is started, the processor 104a of the host PC 104 starts executing the HMI program (Step S500).

Firstly, a driver of the host PC 104 reads the key code from the dongle connected to the client PC 2 (Step S501). In other words, the driver reads the key code from the virtualized hardware key representing the dongle that is connected to the client PC 2 and that is virtualized by the host-side remote monitoring software as the dongle connected to the host PC 104.

Then, the HMI program reads the key code stored in a storage unit such as the ROM 104c and the HDD 104d (Step S502). Subsequently, the HMI program determines whether or not the key code read from the virtualized hardware key matches with the key code read from the storage unit such as the ROM 104c or the HDD 104d (Step S503).

If the key code read from the virtualized hardware key does not match with the key code read from the storage unit such as the ROM 104c or the HDD 104d (No at Step S503), then the execution of the HMI program is ended (Step S504).

On the other hand, if the key code read from the virtualized hardware key matches with the key code read from the storage unit such as the ROM 104c or the HDD 104d (Yes at Step S503), then the HMI program generates an HMI screen. Then, the host-side remote monitoring software sends the generated HMI screen to the client PC 2 (Step S505).

Subsequently, the processor 104a determines whether or not the session based on remote desktop connection is ongoing between the client PC 2 and the host PC 104 (Step S506). If the session based on remote desktop connection is ongoing between the client PC 2 and the host PC 104 (Yes at Step S506), then the system control returns to Step S505 and the host-side remote monitoring software continues with sending the HMI screen to the client PC 2.

On the other hand, if the session based on remote desktop connection between the client PC 2 and the host PC 104 has ended (No at Step S506), then the HMI programs ends the generation of the HMI screen (Step S507). Subsequently, the processor 104a of the host PC 104 ends the execution of the HMI program (Step S504).

In this way, in the remote monitoring system according to the first embodiment, when remote desktop connection with the host PC 104 is established by a plurality of client PCs 2, the HMI program corresponding to each client PC 2 can authenticate the concerned client PC 2 using the key code stored in the dongle that is connected to the concerned client PC 2. As a result, any client PC 2 not having the license for using the HMI program can be prevented from displaying the HMI screen in an unauthorized manner.

### Second Embodiment

In a second embodiment, the processor of the host PC implements a plurality of virtual machines, and executes the host-side remote monitoring software and the HMI program in each virtual machine. In the following explanation, the identical configuration to the first embodiment is referred to by the same reference numerals.

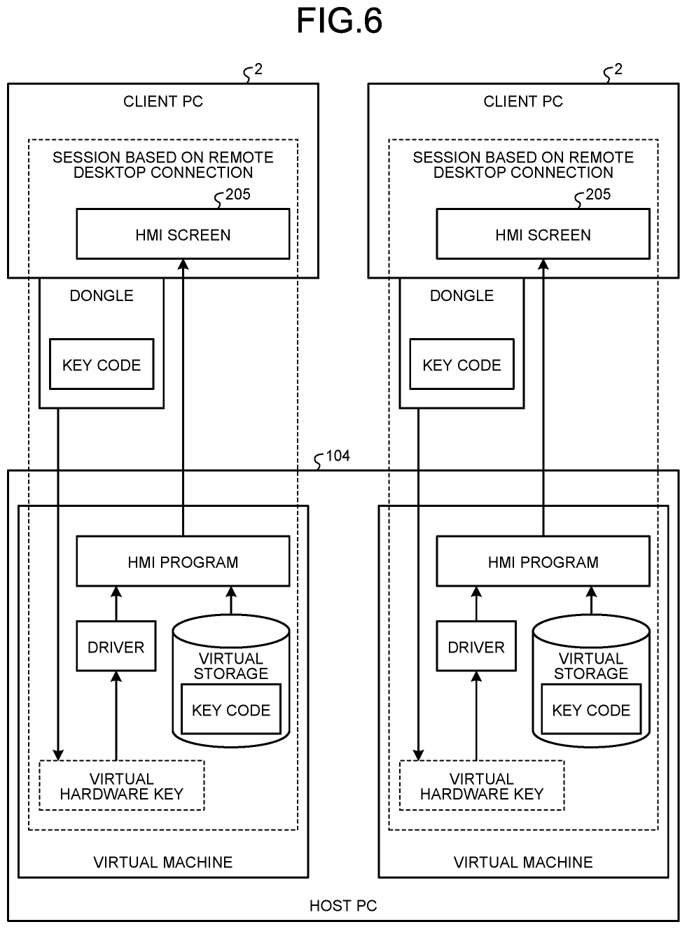

FIG. 6 is a diagram for explaining an example of the operations performed for displaying an HMI screen in a client PC in the remote monitoring system according to the second embodiment.

Firstly, the processor 104a of the host PC 104 executes the OS and implements a plurality of virtual machines. A virtual machine is a machine in which the hardware of the host PC 104 is virtualized. In other words, a virtual machine is a machine in which the hardware of the host PC 104 is emulated. In the second embodiment, the processor 104a is a multicore processor that has a plurality of CPU cores and that executes a variety of software in each CPU core. Herein, each virtual machine is executed by a different CPU core.

Each virtual machine executes a guest OS in which the host-side remote monitoring software is installed, and starts a session based on remote desktop connection between itself and the client PC 2. The host-side remote monitoring software virtualizes the dongle, which is connected to the client PC 2, as a dongle connected to the virtual machine.

Then, the virtual machine executes the HMI program in the guest OS. If the key code stored in the dongle virtualized by the host-side remote monitoring software matches with the key code stored in a virtual storage unit of the virtual machine, then the HMI program generates an HMI screen. The virtual storage unit is implemented using a storage unit such as the ROM 104c or the HDD 104d, and is used to store the key code. Meanwhile, if the read key code does not match with the key code stored in the virtual storage unit, then the execution of the HMI program is ended.

In this way, in the remote monitoring system according to the second embodiment, even when the HMI program is executed in a virtual machine, the client PC 2 can be authenticated according to the procedure identical to the procedure followed in the first embodiment. As a result, any client PC 2 not having the license for using the HMI program can be prevented from displaying the HMI screen in an unauthorized manner.

### Third Embodiment

In a third embodiment, a client-side remote monitoring software of the client PC receives an HMI screen from each of a plurality of host PCs and displays the received HMI screens in the display. In the following explanation, the identical configuration to the embodiments described above is referred to by the same reference numerals.

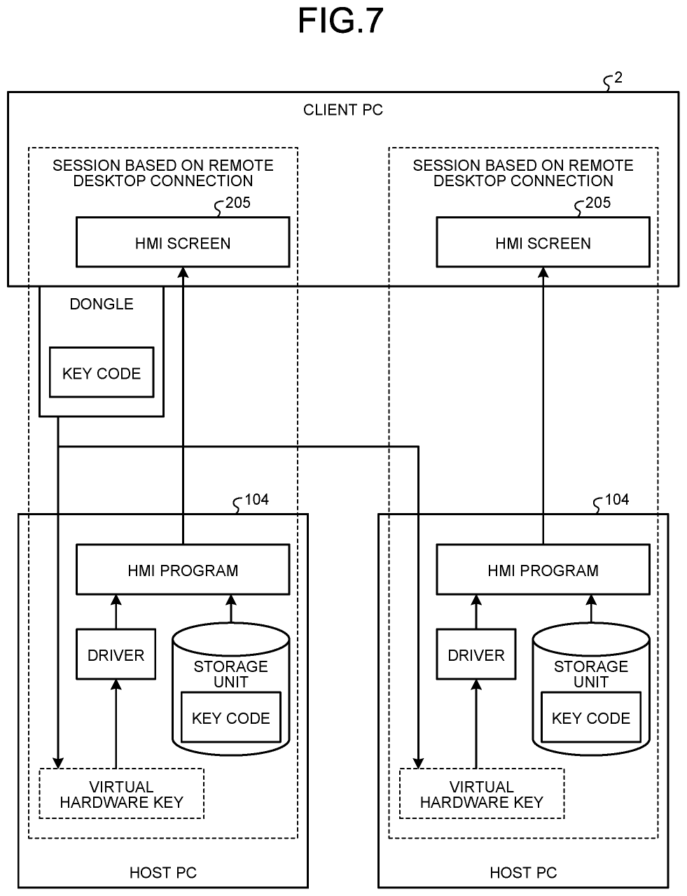

FIG. 7 is a diagram for explaining an example of the operations performed for displaying HMI screens in a client PC in the remote monitoring system according to the third embodiment.

The client-side remote monitoring software establishes connection between the client PC 2 and a plurality of host PCs 104 based on remote desktop. Then, the client-side remote monitoring software receives the HMI screen from each of a plurality of host PCs 104, and displays the received HMI screens in the display 105. As a result, the HMI screens displayed in a plurality of host PCs 104 due to the HMI program can be confirmed in a single client PC 2.

In each host PC 104, the host-side remote monitoring software that is executed by the processor 104a starts a session between the host PC 104 and the client PC 2 based on remote desktop connection. Moreover, the host-side remote monitoring software virtualizes the dongle, which is connected to the client PC 2, as a dongle connected to the own device (the host PC 104).

Then, the processor 104a executes the HMI program. If the key code stored in the dongle virtualized by the host-side remote monitoring software matches with the key code stored in a storage unit such as the ROM 104c or the HDD 104d, then the HMI program generates an HMI screen. On the other hand, if the key code stored in the virtualized dongle does not match with the key code stored in the storage unit, then the execution of the HMI program is ended.

In this way, in the remote monitoring system according to the third embodiment, the HMI screens displayed in a plurality of host PCs 104 due to the HMI program can be confirmed in a single client PC 2.

As explained above, according to the first to third embodiments, any client PC 2 not having the license for using the HMI program can be prevented from displaying the HMI screen in an unauthorized manner.

Herein, although the present invention is described with reference to the abovementioned embodiments for a complete and clear disclosure, the appended claims are not to be thus limited but are to be construed as embodying all modifications and alternative constructions that may occur to one skilled in the art that fairly fall within the basic teaching herein set forth.

1. A monitoring control device comprising:
a host-side storage unit configured to store an HMI program, host-side remote monitoring software, and a key code, the HMI program being configured to generate a monitoring operation screen, the host-side remote monitoring software being configured to establish connection between an own device and a client PC according to a remote desktop protocol and send the monitoring operation screen to the client PC; and
a host-side processor configured to execute the host-side remote monitoring software and the HMI program, wherein
the host-side remote monitoring software is configured to virtualize a dongle connected to the client PC, as a dongle connected to the monitoring control device, and
the HMI program is configured to end execution of the HMI program if a key code stored in the virtualized dongle does not match with the key code stored in the host-side storage unit.

2. The monitoring control device according to claim 1, wherein the host-side processor is configured to implement a plurality of virtual machines and execute the host-side remote monitoring software and the HMI program in each of the plurality of virtual machines.

3. A client PC connected to the monitoring control device according to claim 1 via a network, the client PC comprising:
a display;
a client-side storage unit configured to store client-side remote monitoring software configured to establish connection between itself and the monitoring control device according to a remote desktop protocol; and
a client-side processor configured to execute the client-side remote monitoring software, wherein
the client-side remote monitoring software is configured to receive the monitoring operation screen from each of a plurality of monitoring control devices, and display a plurality of received monitoring operation screens on the display.
